(19) United States
(12) Patent Application Publication
(10) Pub. No.: US 2007/0187445 A1
(43) Pub. Date: Aug. 16, 2007

(54) Fastening buckle for safety straps

(75) Inventor: Vladimir Krapka, Semily (CZ)

Correspondence Address: BUCHANAN, INGERSOLL & ROONEY PC, POST OFFICE BOX 1404, ALEXANDRIA, VA, 22313-1404, US

(73) Assignee: Singing Rock, S.R.O., Ponikla (CZ)

(21) Appl. No.: 10/565,207

(22) PCT Filed: Jul. 20, 2004
(86) PCT No.: PCT/CZ04/00038

§ 371 Date: Jan. 16, 2007

(30) Foreign Application Priority Data
Jul. 23, 2003 (CZ) PV 2003-2010

(51) Int. Cl. A44B 11/12; A01K 97/04

(52) U.S. Cl. 224/197; 24/170

(57) ABSTRACT

The present invention is related to a fastening buckle intended for fastening safety straps, especially webbing of mountaineering and climbing harnesses and/or harnesses for securing persons working in height. The buckle comprises an upper frame (1) and a lower frame (2). One of the lateral sides (5) of the upper frame (1) is interrupted by a gap (6) having greater width than the thickness of the fastened strap (3). For preventing the possibility of cutting the fastened strap (3) in the transversal slot (14) between lower frame (2) and upper frame (1) at dynamic load, it is useful to bend the second long side (10) of the lower frame (2) at a sharp angle (a) with respect to the plane of the first long side (8) of the lower frame (2). For preventing the possibility of the upper frame (1) accidentally falling out of the strap loop (4), the upper frame (1) may comprise a middle transversal part (15) or the first and second long side (7, 8) of the upper and lower frame (1, 2) may be secured with a securing sleeve (9).

### TECHNICAL FIELD

The present invention is related to fastening buckles for straps, in particular safety straps, primarily for use in mountaineering and climbing harnesses and/or harnesses for securing persons working in height, for example on building sites.

### BACKGROUND ART

For the climbing harnesses as cited above, it is known to use self-clamping buckles comprising two rings in form of rectangular frames having different sizes, for connecting the two ends of a strap made mostly of synthetic webbing. Such a buckle is described for example in document US-A-5432984. According to this document, the buckle is held fixed on one end of the strap in a stitched or otherwise unalterably attached loop, in such way that the frames are superposed according to two parallel planes. The second—removable—end of the strap passes through the frames from the bottom side of the lower frame, forming a turn around the long side of the upper frame, and back to the bottom part of the lower frame. When locked, the webbing of the second strap end overlaps a part of the strap, in order to prevent the webbing from slipping out of the buckle completely. The buckle is in a locked position as soon as a tightening force is applied to the strap. It is possible to loosen the strap by tilting the buckle with respect to the plane of the connected straps and by simultaneously bending said strap loop connecting both of the frames. To remove the second strap end completely from the buckle, it is necessary to tilt the buckle sufficiently, in order to let the overlapped webbing of the second strap end slide through the transversal slot defined between one of the external edges of the upper frame and the corresponding edge of the lower frame. Similarly, to insert the second strap end, it has to be slid all the way through the transversal slot.

This difficult manipulation for complete removal or insertion of the strap represents a disadvantage of this buckle design. This is especially the case when used in climbing, mountaineering and professional harnesses and even more so in winter conditions, when the straps are stiff and the user's fingers insensitive.

### AIMS OF INVENTION

The present invention aims to provide a buckle for fastening a straps, said buckle allowing easy removal and insertion of the fastened strap.

### DISCLOSURE OF INVENTION

The invention is related to a safety buckle as described in the appended claims.

The main embodiment of the inventions concerns a buckle wherein one of the lateral sides of the upper frame is interrupted by a gap, the width of said gap being larger than the thickness of the strap.

In addition to this feature, a buckle of the invention may have one transversal side of the lower frame in a position wherein said transversal side is bent over a sharp angle with respect to the other transversal side of said lower frame, and preferably bent away from the plane of the upper frame. This bent position allows reducing the risk of cutting the strap during dynamic loading.

The buckle according to the invention allows easy and quick manipulation for complete removal and insertion of the fastened strap, especially in mountaineering and climbing harnesses and/or harnesses for securing persons working in height even in extremely cold weather. After opening the buckle, by means of turning the upper frame into an upright position in relation to the lower frame, the loosened strap loop can be hooked or unhooked from the upper frame, by moving the strap through the gap in the upper frame's lateral side, without the difficult action of sliding the overlapped webbing all the way through the slots of the frames.

According to additional embodiments, the upper frame of the buckle may have a middle transversal part or there may be a sleeve (for example plastic) around two transversal sides of the frames, in order to prevent the accidental loosening of the upper frame.

### BRIEF DESCRIPTION OF DRAWINGS

FIG. 1 shows a front view of the buckle according to the present invention.

FIG. 2 shows the cross section of the buckle in closed position.

FIG. 3 shows the cross section of the buckle in tilted position for releasing the tightening force.

FIG. 4 shows the cross section of the buckle with the upper frame in a position, which allows the user simply to hook or unhook the fastened strap.

FIG. 5 shows front view of an alternative embodiment, wherein the buckle comprises a middle transversal part in the upper frame.

FIG. 6 shows cross section of said alternative embodiment, wherein the buckle comprises a middle transversal part in the upper frame.

FIG. 7 shows the cross section of a further embodiment, wherein the buckle is equipped with a securing sleeve.

### BEST MODE FOR CARRYING OUT THE INVENTION

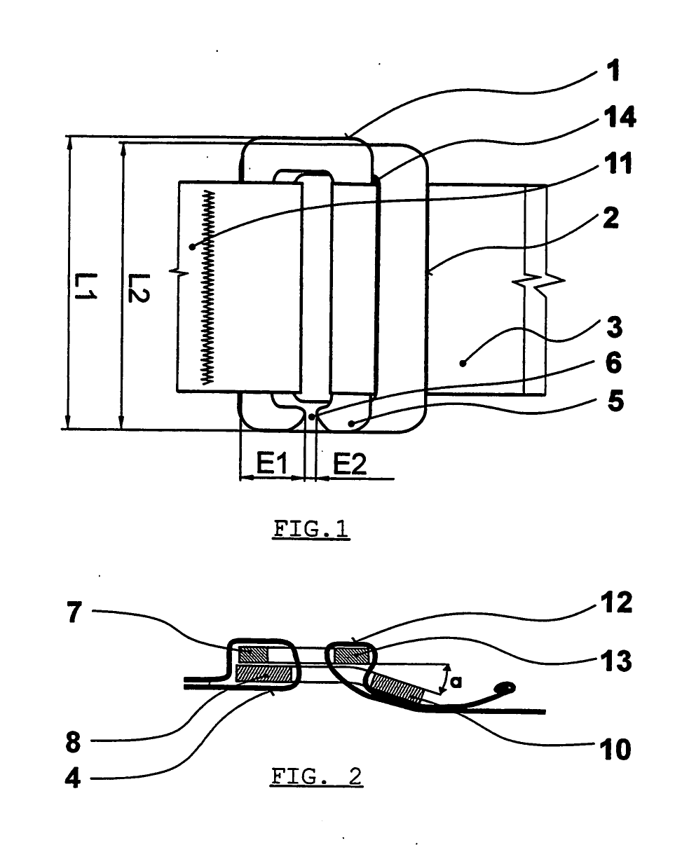

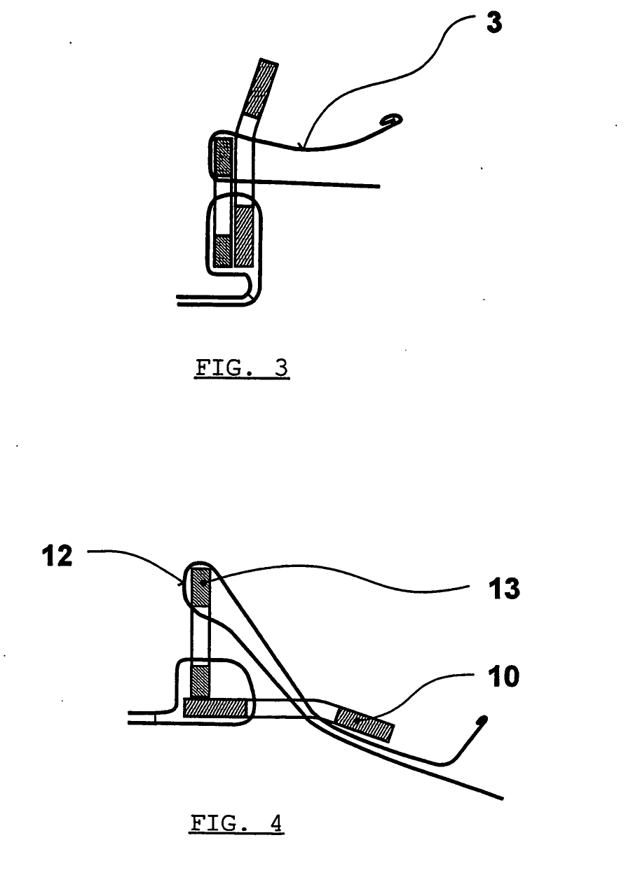

The preferred embodiment of a fastening buckle according to the invention is shown in FIGS. 1 and 2. The buckle comprises two rectangular frames 1,2; a lower frame 2 and an upper frame 1, superposed according to two parallel planes for fastening straps 3 and 11. The frames 1,2 have long sides 7, 8, 10, 13 transversal to the longitudinal direction of the fastened straps 3,11 (the ‘transversal sides’), and short sides in said longitudinal direction (the “lateral sides”). Frames 1,2 are held by a strap loop 4, surrounding the long sides 7 and 8 of the frames 1,2; said loop being formed by stitching the end of the strap 11, thereby creating a fixed strap loop 4. The fastened strap 3 is held in a loop 12 between the opposite long sides 10 and 13 of the frames 1,2; so that the fastened strap 3 passes through transversal slot 14 between said long sides 10 and 13. When the fastened strap 3 is tightened by application of a tightening force, the clamping action is sufficient to prevent slippage of the fastened strap 3 from the transversal slot 14.

The buckle of the invention is characterized in the first place by the presence of a gap 6 in one of the lateral sides 5 of the upper frame 1. The width E2 of the gap 6 is larger than the thickness of the fastened strap 3. Furthermore, the distance E1 from the edge of the gap 6 to the edge of the first long side 7 of the upper frame 1 is high enough to prevent accidental loss of the upper frame 1 from the strap loop 4.

FIG. 3 shows the buckle being tilted over approximately 90° with respect to the clamping position of FIG. 2. In this position the friction force applied to the fastened strap 3 is reduced and thus allows tightening and loosening of the fastened strap 3.

FIG. 4 shows a way of opening the buckle by turning the upper frame 1 into an upright position in relation to the lower frame 2. In this way, it is possible to unhook the loop 12 on the fastened strap 3 from the second long side 13 of the upper frame 1 by sliding the fastened strap 3 through the gap 6 and subsequently drawing out the loop 12 from the buckle. This is the improvement of the invention with respect to the prior art. With a buckle of the invention, the fastened strap 3 can be removed in a quick and easy way. It is also possible to re-insert the fastened strap 3 in an analogue way, by forming the loop 12 and inserting it through the gap 6. The manipulation required for completely removing or inserting the fastened strap 3 to or from the buckle is thereby simplified with a buckle of the invention.

Further according to the preferred embodiment of the invention, the second long side 10 of the lower frame 2 is bent at a sharp angle α with respect to the plane of the first long side 8 of the lower frame 2 (FIG. 2). In the embodiment of FIG. 2, the second long side 10 is bent away from the plane of the upper frame 1. This angle α reduces the risk of cutting the fastened strap 3 in the transversal slot 14 during dynamic loading.

For easy manipulation, the width L1 of the upper frame 1 exceeds the width L2 of the lower frame 2.

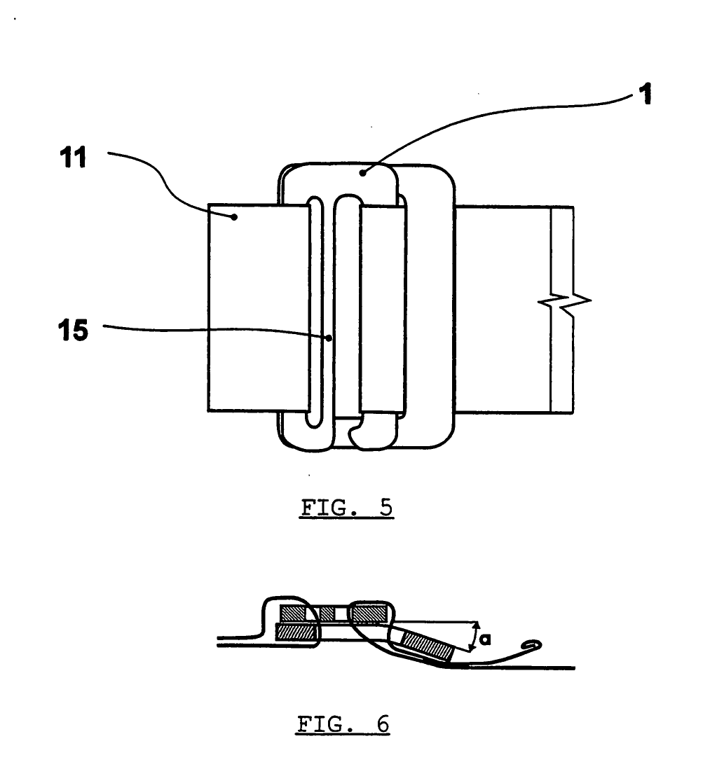

FIG. 5 and FIG. 6 show a further improved design of the buckle, wherein the upper frame 1 is fitted with a middle transversal part 15, which prevents accidental loss of the upper frame 1 from the strap loop 4 of the strap 11.

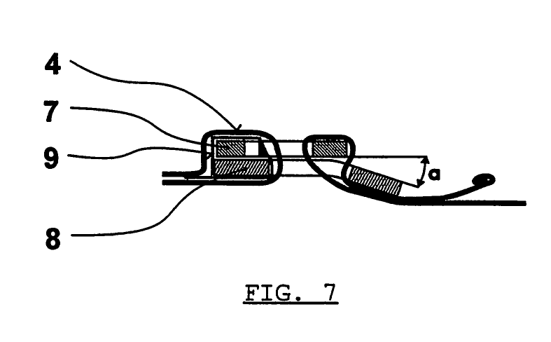

FIG. 7 shows another design of the buckle fitted with another type of securing against accidental loss of the upper frame 1. In this embodiment, the first long side 7 of the upper frame 1 and the first long side 8 of the lower frame 2 are secured with a securing sleeve 9 made out of, for example, mechanically resistant plastic.

1. A fastening buckle for a safety straps, comprising an upper frame (1) and a lower frame (2) of different sizes, wherein each frame (1,2) comprises a first long side (7,8) for being connected to a fixed strap loop (4) of a first strap (11) and a second long side (10,13) for being connected to a second fastened strap (3), said long sides (7,8,10,13) being transversal to the longitudinal direction of the straps (3,11) and wherein each frame (1,2) equally comprises two lateral sides in said longitudinal direction, characterized in that one lateral side (5) of the upper frame (1) is interrupted by a gap (6), said gap (6) having a width (E2) which is larger than the thickness of the fastened strap (3).

2. The fastening buckle according to claim 1, characterized in that the second long side (10) of the lower frame (2) is bent at a sharp angle (α) with respect to the plane of the first long side (8) of the lower frame (2).

3. The fastening buckle according to claim 2, characterized in that said second long side (10) is bent away from the plane of the upper frame (1).

4. The fastening buckle according to claim 1, characterized in that the width (L1) of the upper from (1) exceeds the width (L2) of the lower frame (2).

5. The fastening buckle according to claim 1, characterized in that the upper frame (1) further comprises a middle transversal part (15) for maintaining a first strap (11).

6. The fastening buckle according to claim 1, characterized in that said first long sides (7,8) of said frames (1,2) are secured by a securing sleeve (9).
